(19) United States
(12) Patent Application Publication
(10) Pub. No.: US 2026/0066318 A1
(43) Pub. Date: Mar. 5, 2026

(54) FUEL CELL APPARATUS

(71) Applicants: HYUNDAI MOTOR COMPANY, Seoul (KR); KIA CORPORATION, Seoul (KR)

(72) Inventor: Dae Han Ka, Hwaseong-si (KR)

(73) Assignees: HYUNDAI MOTOR COMPANY, Seoul (KR); KIA CORPORATION, Seoul (KR)

(21) Appl. No.: 19/054,220

(22) Filed: Feb. 14, 2025

(30) Foreign Application Priority Data
Sep. 2, 2024 (KR) 10-2024-0118630

(51) Int. Cl. H01M 8/04537

(52) U.S. Cl. CPC H01M 8/04552

(57) ABSTRACT

A fuel cell apparatus includes: a fuel cell, including unit cells stacked in a first direction and separators spaced apart from each other in the first direction; and a cell connector mounted to the fuel cell in a second direction intersecting the first direction. The separators include first and second separators adjacent to each other. The fuel cell further includes a first gasket disposed so as to form a recess contacting an edge of the first separator, a second gasket disposed on the second separator while facing the recess in the first direction to define a receiving slot together with the recess, and a first terminal portion disposed in the receiving slot. The cell connector includes a second terminal portion inserted into the receiving slot in the second direction to be engaged with the first terminal portion in a contact manner in the first direction.

### CROSS-REFERENCE TO RELATED APPLICATIONS

This application claims the benefit of and priority to Korean Patent Application No. 10-2024-0118630, filed on Sep. 2, 2024, which is hereby incorporated by reference in its entirety.

### BACKGROUND

### Technical Field

The present disclosure relates to a fuel cell apparatus.

### Related Art

A cell stack of a fuel cell (hereinafter referred to as a “fuel cell stack”) may supply power, generated through electrochemical reaction between air supplied to one surface of a polymer electrolyte membrane and hydrogen supplied to the opposite surface of the polymer electrolyte membrane, to an external load.

A fuel cell stack may have a structure in which hundreds of cells are stacked. If unit cells operate normally during operation of the fuel cell stack, the unit cells may generate a predetermined magnitude of voltage. If any one of hundreds of cells fails to exhibit normal performance, the total output of the fuel cell stack is lowered. If this reverse voltage phenomenon continues, operation of the fuel cell stack needs to be stopped.

A cell monitoring connector (hereinafter referred to as a “cell connector”) checks the state of each of cells and continuously monitors the voltage of each of cells. To this end, the cell connector may electrically contact the cells in order to check the voltage of each of unit cells of the fuel cell stack. Various research with the goal of simplifying a fastening structure between a cell connector and a fuel cell stack is underway.

### SUMMARY

Accordingly, embodiments of the present disclosure are directed to a fuel cell apparatus that substantially obviates one or more problems due to limitations and disadvantages of the related art.

Embodiments of the present disclosure provide a fuel cell apparatus having a cell connector having a simple configuration and capable of being easily fastened.

However, the objects to be accomplished by the present disclosure are not limited to the above-mentioned objects. Other objects not mentioned herein should be more clearly understood by those having ordinary skill in the art from the following description.

Additional advantages, objects, and features of the disclosure are set forth in part in the description which follows and in part should become apparent to those having ordinary skill in the art upon examination of the following or may be learned from practice of the disclosure. Further, objects and other advantages of the disclosure may be realized and attained by the structure particularly pointed out in the written description and claims hereof as well as the appended drawings.

A fuel cell apparatus according to an embodiment may include: a fuel cell including a plurality of unit cells stacked in a first direction and separators disposed so as to be spaced apart from each other in the first direction; and a cell connector mounted to the fuel cell in a second direction intersecting the first direction. The separators may include a plurality of pairs of separators (i.e., a plurality of separator pairs), each separator pair including first and second separators adjacent to each other. The fuel cell may further include: a first gasket disposed so as to form a recess contacting an edge of the first separator, the first gasket being insulative; a second gasket disposed on the second separator while facing the recess in the first direction to define a receiving slot together with the recess, the second gasket being insulative; and a first terminal portion removably disposed in the receiving slot, the first terminal portion being elastic in the first direction. The cell connector may include a second terminal portion inserted into the receiving slot in the second direction to be engaged with the first terminal portion in a contact manner in the first direction.

In an example, the first terminal portion may include an elastic piece bent from the edge to the interior of the recess so as to have a curved shape. Further, the second terminal portion may be in contact with the elastic piece.

In an example, the elastic piece may include a first end connected to the edge, a second end located opposite the first end in the second direction, and an intermediate portion disposed between the first end and the second end. The intermediate portion may have the curved shape.

In an example, the recess may include a bottom surface connected to the first end and spaced apart from the second end in the first direction, and may include a side surface facing a third end of the second terminal portion, inserted into and received in the receiving slot, in the second direction. The side surface may extend from the bottom surface in the first direction.

In an example, a length of the bottom surface in the second direction may be determined so that the elastic piece of the first terminal portion engaged with the second terminal portion is maintained in the curved shape by stopping movement of the second end in the second direction.

In an example, the elastic piece may further include a first protruding portion bent and protruding from the second end in the first direction away from the bottom surface.

In an example, the first separator may include a second protruding portion bent and protruding from the bottom surface in the first direction and spaced apart from the second end and the side surface.

In an example, the elastic piece may have a first length in the second direction before being bent to have the curved shape. The first length may be longer than a second length from the edge of the bottom surface to the side surface.

In an example, the elastic piece may have a third length in the second direction after being bent to have the curved shape. The third length may be shorter than the second length.

In an example, the third length may be shorter than a fourth length of the second terminal portion in the second direction.

In an example, the fuel cell apparatus may further include an insulating layer disposed between the first gasket and the second gasket to define the receiving slot together with the recess. The first and second separators may be included in each of the plurality of unit cells.

In an example, the plurality of unit cells may include first and second unit cells adjacent to each other. The first separator may be included in one of the first and second unit cells, and the second separator may be included in the other of the first and second unit cells.

In an example, a first width of the receiving slot in a third direction intersecting each of the first and second directions may be greater than a second width of the second terminal portion in the third direction.

In an example, a third width of the first terminal portion in the third direction may be less than the second width.

In an example, a first thickness of the second terminal portion in the first direction may be greater than a second thickness of the first separator.

In an example, the first thickness may be determined as follows:

T1<T3−T2.

In the above expression, T1 represents the first thickness, T2 represents the second thickness, and T3 represents a third thickness of the first gasket in the first direction.

In an example, the first terminal portion and the second terminal portion may be engaged with each other in a surface contact manner.

In an example, the fuel cell apparatus may further include a controller connected to a fourth end of the second terminal portion. The fourth end may be opposite the third end. The controller may be configured to measure voltage of each of the plurality of unit cells.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a conceptual diagram of a fuel cell apparatus according to an embodiment;

FIG. 2A is a cross-sectional view of end plates and a cell stack in a fuel cell according to an embodiment;

FIG. 2B is a perspective view of separators in the cell stack according to an embodiment;

FIG. 3A is a view of an embodiment of the fuel cell apparatus shown in FIG. 1 when viewed in a second direction;

FIG. 3B is a view of another embodiment of the fuel cell apparatus shown in FIG. 1 when viewed in the second direction;

FIG. 4A is a perspective view of the fuel cell apparatus of FIG. 3A;

FIG. 4B is a perspective view of the fuel cell apparatus of FIG. 3B;

FIG. 5A is a partial side view of a first separator, a first gasket, and a first terminal portion according to an embodiment;

FIG. 5B is a partial perspective view of a first separator, a first gasket, and an first terminal portion according to an embodiment;

FIG. 6 is a partial side view of a second separator and a second gasket according to an embodiment;

FIG. 7 is a cross-sectional view taken along line A-A′ of the fuel cell apparatus shown in FIG. 4B;

FIGS. 8A and 8B are partial side views of a first separator and a first gasket for explaining a process of manufacturing a first terminal portion according to an embodiment;

FIGS. 9A-9C are, respectively, a partial side view, a partial perspective view, and a partial plan view of a first separator, a first gasket, and a first terminal portion according to another embodiment; and

FIG. 9D is a partial perspective view of a first separator, a first first terminal portion according to still another embodiment.

### DETAILED DESCRIPTION

The present disclosure is described more fully hereinafter with reference to the accompanying drawings, in which various embodiments are shown. The examples, however, may be embodied in many different forms, and should not be construed as being limited to embodiments set forth herein. Rather, embodiments are provided so that this disclosure is more thorough and complete, and more fully clearly convey the scope of the disclosure to those having ordinary skill in the art.

It should be understood that when an element is referred to as being “on” or “under” another element, it may be directly on/under the element, or one or more intervening elements may also be present.

When an element is referred to as being “on” or “under” an element, both “under the element” as well as “on the element” may be included based on the element. Further, when a certain component is said to be “adjacent to” another component, this may mean that the certain component is close to, near to, and/or next to the other component, and/or the certain component is disposed within a predetermined distance from the other component.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

When a component, unit, controller, device, element, apparatus, or the like (i.e., an apparatus) of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Hereinafter, a fuel cell apparatus according to an embodiment is described with reference to the accompanying drawings. The fuel cell apparatus is described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but embodiments are not limited thereto. In other words, the x-axis, the y-axis, and the z-axis may intersect each other obliquely. In the following description, the x-axis direction may be referred to as a “first direction”, the y-axis direction may be referred to as a “second direction”, and the z-axis direction may be referred to as a “third direction”.

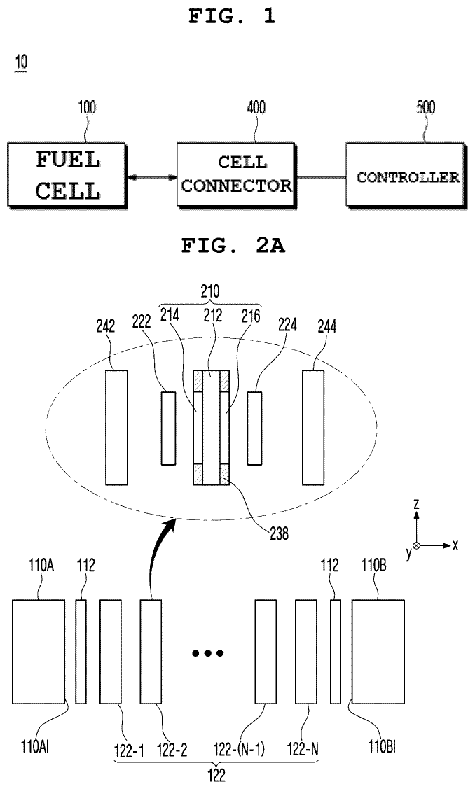

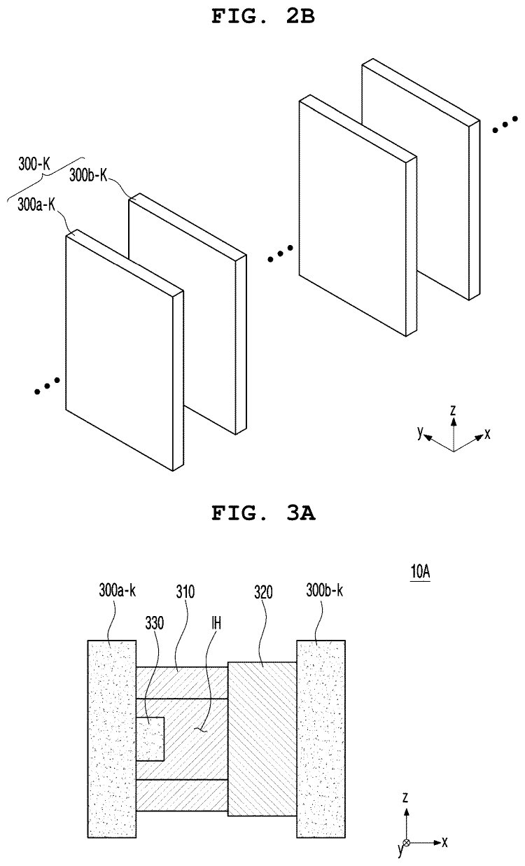

FIG. 1 is a conceptual diagram of a fuel cell apparatus 10 according to an embodiment. FIG. 2A is a cross-sectional view of end plates (pressing plates or compression plates) 110A and 110B and a cell stack 122 in a fuel cell 100. FIG. 2B is a perspective view of separators in the cell stack 122.

The fuel cell apparatus 10 according to an embodiment may include a fuel cell 100, a cell monitoring connector (hereinafter referred to as a “cell connector) 400, and a controller (or control circuit) 500.

The fuel cell 100, to and from which the cell connector 400 according to an embodiment may be mounted and removed in the directions of arrows, may be, for example, a polymer electrolyte membrane fuel cell (or proton exchange membrane fuel cell) (PEMFC), which may be used as a power source for driving vehicles. However, embodiments are not limited thereto.

The fuel cell 100 may include end plates 110A and 110B and a cell stack 122.

The cell stack 122 may include a plurality of unit cells 122-1 to 122-N, which are stacked in the first direction. The expression “N” is a positive integer of 1 or greater and may range from several tens to several hundreds. The positive integer “N” may range, for example, from 100 to 300. For example, “N” may be 220. However, embodiments are not limited to any specific value of “N”. Each of the unit cells 122-1 to 122-N may be referred to as “122-n.”

Each unit cell 122-n may generate 0.6 volts to 1.0 volt of electricity, on average 0.7 volts of electricity (1≤n≤N). Therefore, “N” may be determined depending on the intensity of the power to be supplied from the fuel cell 100 to a load. The load refers to a part of a vehicle that requires power when the fuel cell 100 is used in the vehicle.

Each unit cell 122-n may include a membrane electrode assembly (MEA) 210, gas diffusion layers (GDLs) 222 and 224, separators (or bipolar plates) 242 and 244, and gaskets.

The membrane electrode assembly 210 has a structure in which catalyst electrode layers, in which electrochemical reaction occurs, are attached to both sides of an electrolyte membrane through which hydrogen ions move. In detail, the membrane electrode assembly 210 may include a polymer electrolyte membrane (or a proton exchange membrane) 212, a fuel electrode (a hydrogen electrode or an anode) 214, and an air electrode (an oxygen electrode or a cathode) 216. In addition, the membrane electrode assembly 210 may further include a sub-gasket 238.

The polymer electrolyte membrane 212 is disposed between the fuel electrode 214 and the air electrode 216.

Hydrogen, which is fuel in the fuel cell 100, may be supplied to the fuel electrode 214 through the left separator 242, and air containing oxygen as an oxidizer may be supplied to the air electrode 216 through the right separator 244.

The hydrogen supplied to the fuel electrode 214 is decomposed into hydrogen ions (protons) (H+) and electrons (e−) by the catalyst. Only the hydrogen ions may be selectively transferred to the air electrode 216 through the polymer electrolyte membrane 212, and at the same time, the electrons may be transferred to the air electrode 216 through the separators 242 and 244, which are conductors. In order to realize the above operation, a catalyst layer may be applied to each of the fuel electrode 214 and the air electrode 216. The movement of the electrons described above causes the electrons to flow through an external wire, thus generating current. In other words, the fuel cell 100 may generate power due to the electrochemical reaction between hydrogen, which is fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (“condensed water” or “product water”).

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The gas diffusion layers 222 and 224 serve to uniformly distribute hydrogen and oxygen, which are reactant gases, and to transfer the generated electrical energy. To this end, the gas diffusion layers 222 and 224 may be disposed on respective sides of the membrane electrode assembly 210. In other words, the first gas diffusion layer 222 may be disposed on the left side of the fuel electrode 214, and the second gas diffusion layer 224 may be disposed on the right side of the air electrode 216.

The first gas diffusion layer 222 may serve to diffuse and uniformly distribute hydrogen supplied as a reactant gas through the left separator 242. The first gas diffusion layer 222 may be electrically conductive. The second gas diffusion layer 224 may serve to diffuse and uniformly distribute air supplied as a reactant gas through the right separator 244. The second gas diffusion layer 224 may be electrically conductive.

Each of the first and second gas diffusion layers 222 and 224 may be a microporous layer in which fine carbon fibers are combined. However, embodiments are not limited to any specific form of the first and second gas diffusion layers 222 and 224.

The separators 242 and 244 may serve to move the reactant gases and the cooling medium and to separate each of the unit cells from the other unit cells. In addition, the separators 242 and 244 may serve to structurally support the membrane electrode assembly 210 and the gas diffusion layers 222 and 224 and to collect the generated current and transfer the collected current to current collectors 112.

The separators 242 and 244 may be disposed outside the gas diffusion layers 222 and 224, respectively. In other words, the left separator 242 may be disposed on the left side of the first gas diffusion layer 222, and the right separator 244 may be disposed on the right side of the second gas diffusion layer 224.

The left separator 242 serves to supply hydrogen as a reactant gas to the fuel electrode 214 through the first gas diffusion layer 222. The right separator 244 serves to supply air as a reactant gas to the air electrode 216 through the second gas diffusion layer 224. In addition, each of the separators 242 and 244 may form a channel through which a cooling medium (e.g. coolant) may flow. Further, the separators 242 and 244 may be formed of a graphite-based material, a composite graphite-based material, or a metal-based material. However, embodiments are not limited to any specific material of the separators 242 and 244.

The end plates 110A and 110B shown in FIG. 2A may be disposed at the respective ends of the cell stack 122 and may support and fix the unit cells 122-n. In other words, the first end plate 110A may be disposed at one end of the cell stack 122, and the second end plate 110B may be disposed at the opposite end of the cell stack 122.

Each of the end plates 110A and 110B may be configured such that a metal insert is surrounded by a plastic injection-molded product. The metal insert of each of the end plates 110A and 110B may have high rigidity to withstand internal surface pressure, and may be formed by machining a metal material. For example, each of the end plates 110A and 110B may be formed by combining a plurality of plates. However, embodiments are not limited to any specific configuration of the end plates 110A and 110B.

The current collectors 112 may be disposed between the cell stack 122 and the inner surfaces 110AI and 110BI of the end plates 110A and 110B that face the cell stack 122. The current collectors 112 serve to collect the electrical energy generated by the flow of electrons in the cell stack 122 and to supply the electrical energy to a load that uses the fuel cell.

Further, the first end plate 110A may include a plurality of manifolds (or communicating portions) M. Each of the separators 242 and 244 shown in FIG. 2A may include manifolds that are formed in the same shape at the same positions as the manifolds of the first end plate 110A. The manifolds may include an inlet manifold and an outlet manifold. Hydrogen and oxygen, which are reactant gases necessary in the membrane electrode assembly 210, may be introduced from the outside into the cell stack 122 through the inlet manifold. Gas or liquid, in which the reactant gases humidified and supplied to the cell and the condensed water generated in the cell are combined, may be discharged to the outside of the fuel cell through the outlet manifold. The cooling medium may flow from the outside into the cell stack 122 through the inlet manifold and may flow from the cell stack 122 to the outside through the outlet manifold. As described above, the manifolds allow the fluid to flow into and out of the membrane electrode assembly 210.

In order to determine the performance of the cell stack 122 and whether the cell stack 122 operates normally or abnormally, the separator 242 or 244 of each cell may be connected to the controller 500 via the cell connector 400. In this way, the voltage of each cell may be measured.

In order to explain connection between the cell connector 400 and the separator 242 or 244, only the separator 242 or 244 of each cell included in the fuel cell 100 is shown in FIG. 2B.

Referring to FIG. 2B, the fuel cell 100 may include a plurality of pairs of separators 300-k. Each of the pairs of separators 300-k (1≤k≤N/2) may include first and second separators 300a-k and 300b-k adjacent to each other.

The cell connector 400 may be mounted to the fuel cell 100 in the second direction intersecting the first direction.

Hereinafter, the configuration of the cell connector 400 and the configuration of the fuel cell 100 into which the cell connector 400 is inserted are described.

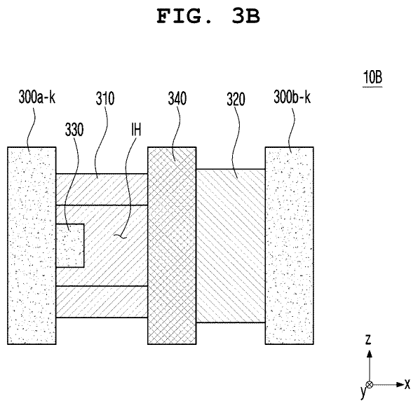

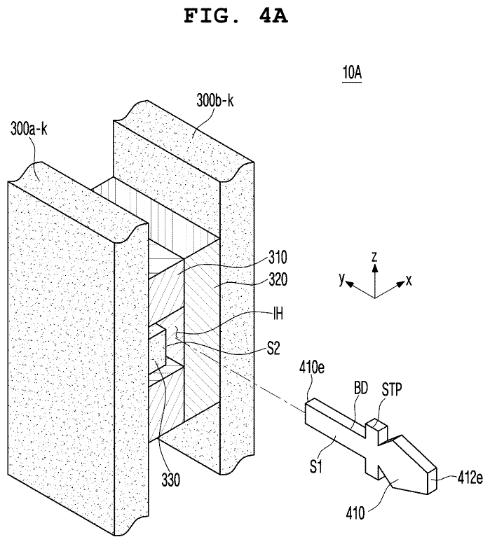

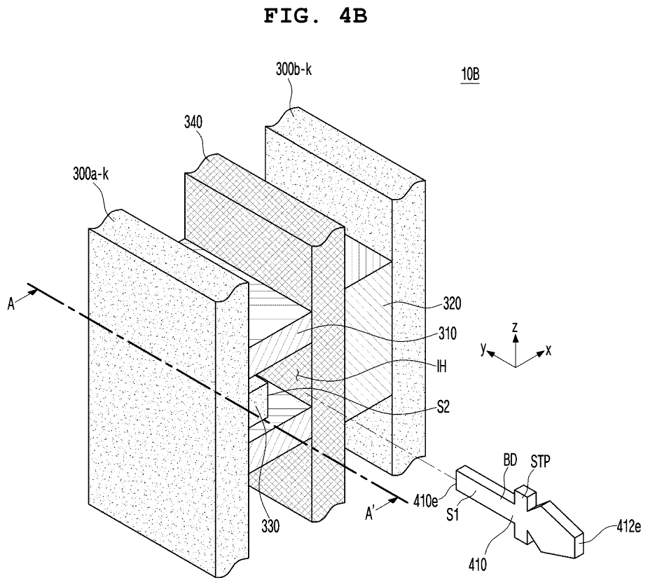

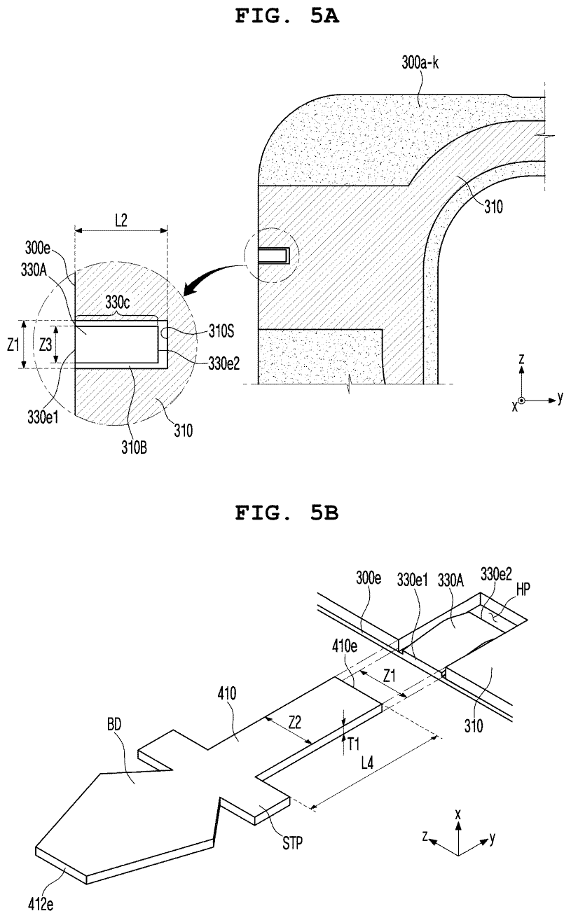

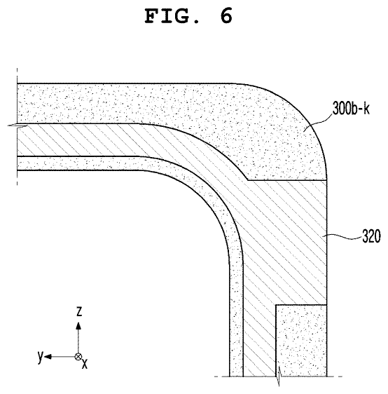

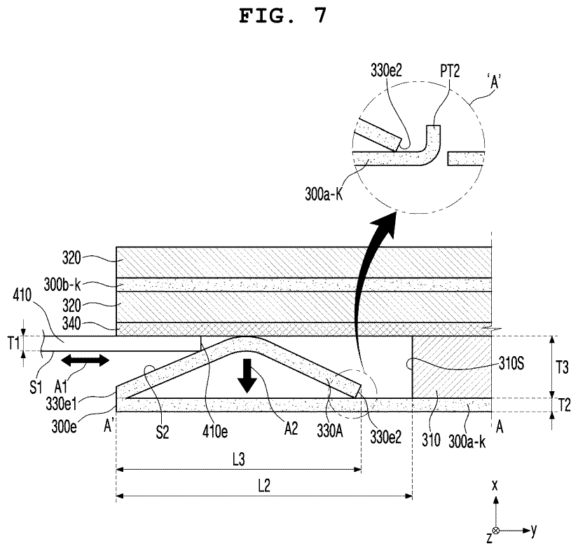

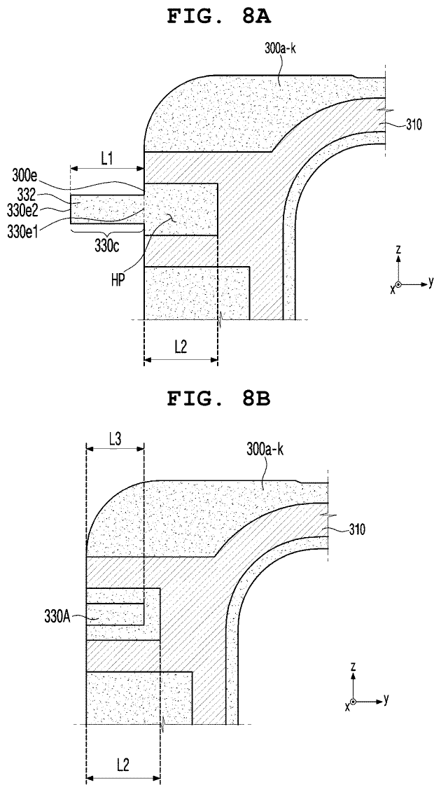

FIG. 3A is a view of an embodiment 10A of the fuel cell apparatus 10 shown in FIG. 1 when viewed in the second direction in which the cell connector 400 is inserted. FIG. 3B is a view of another embodiment 10B of the fuel cell apparatus 10 shown in FIG. 1 when viewed in the second direction. FIG. 4A is a perspective view of FIG. 3A. FIG. 4B is a perspective view of FIG. 3B. FIG. 5A is a partial side view of a first separator 300a-k, a first gasket 310, and a first terminal portion 330A according to an embodiment. FIG. 5B is a partial perspective view of the first separator 300a-k, the first gasket 310, and the first terminal portion 330A according to an embodiment. FIG. 6 is a partial side view of a second separator 300b-k and a second gasket 320 according to an embodiment. FIG. 7 is a cross-sectional view taken along line A-A′ shown in FIG. 4B. FIGS. 8A and 8B are partial side views of the first separator 300a-k and the first gasket 310 for explaining a process of manufacturing the first terminal portion 330A.

The first and second gaskets 310 and 320 may serve to maintain airtightness and clamping pressure of the cell stack at an appropriate level with respect to the reactant gases and the coolant, to disperse the stress when the separators 300a-k and 300b-k are stacked, and to independently seal the flow paths. As such, since airtightness and watertightness are maintained by the first and second gaskets 310 and 320. Further, the flatness of the surfaces that are adjacent to the cell stack 122, which generates power, may be secured. Thus, surface pressure may be distributed uniformly over the reaction surface of the cell stack 122. To this end, the first and second gaskets 310 and 320 may be formed of insulative rubber. However, embodiments are not limited to any specific material of the first and second gaskets 310 and 320. The first and second gaskets 310 and 320 may be formed of various materials, so long as the materials are insulative.

When unit cells adjacent to each other among the plurality of unit cells are referred to as first and second unit cells, in the case of FIGS. 3A and 4B, the first separator 300a-k may be one of the separators 242 and 244 included in one of the first and second unit cells, and the second separator 300b-k may be the other of the separators 242 and 244 included in the other of the first and second unit cells and may be adjacent to the first separator 300a-K. For example, the first separator 300a-k may be the separator 244 included in the first unit cell among the first and second unit cells, and the second separator 300b-k may be the separator 242 included in the second unit cell and may be adjacent to the first separator 300a-k.

In the case of FIGS. 3B and 4B, the first separator 300a-k may be one of the aforementioned separators 242 and 244, and the second separator: 300b-k may be the other of the aforementioned separators 242 and 244. In this case, the first and second separators 300a-k and 300b-k may be included in each of the plurality of unit cells.

The first and second gaskets 310 and 320 may be disposed on the first and second separators 300a-k and 300b-k, respectively, in order to prevent electrical short circuit.

According to an embodiment, the first and second gaskets 310 and 320 are disposed on the first and second separators 300a-k and 300b-k, respectively. The first and second gaskets 310 and 320 serve as a housing accommodating the cell connector 400, as described below.

The first gasket 310 may be disposed so as to form a recess HP contacting an edge 300e of the first separator 300a-k.

According to an embodiment, as shown in FIGS. 3A and 4A, the second gasket 320 may be disposed on the second separator 300b-k while facing the recess HP in the first direction, thereby defining a receiving slot IH together with the recess HP. To this end, the first gasket 310 shown in FIG. 8B and the second gasket 320 shown in FIG. 6 may be disposed in one-to-one correspondence with each other in the first direction.

According to another embodiment, as shown in FIGS. 3B and 4B, an insulating layer 340 may be additionally disposed between the first gasket 310 and the second gasket 320. In this case, instead of the second gasket 320, the insulating layer 340 may define the receiving slot IH together with the recess HP. This insulating layer 340 may correspond to the sub-gasket 238 shown in FIG. 2A. For example, the sub-gasket may be implemented as a PEN (polyethylene naphthalate) film.

The case of FIGS. 3A and 4A corresponds to a case in which a first terminal portion 330 is disposed on the cooling surface. In this case, the first and second separators 300a-k and 300b-k have the same potential, so the insulating layer 340 may be omitted.

On the other hand, the case of FIGS. 3B and 4B corresponds to a case in which the first terminal portion 330 is disposed on the reaction surface. In this case, the first and second separators 300a-k and 300b-k configured based on the reaction surface have different potentials, so the insulating layer 340 may be disposed in order to prevent short circuit.

As such, since the receiving slot IH is formed by the first gasket 310 and the second gasket 320 or is formed by the first gasket 310 and the insulating layer 340, the height of the receiving slot IH may correspond to the thickness of the first gasket 310. However, embodiments are not limited thereto.

Because the first terminal portion 330A is disposed in the receiving slot IH, the cell connector 400 may be disposed so as to be mounted or removed in the direction indicated by arrow A1 shown in FIG. 7 and may be elastic in the first direction. Thus, when the cell connector 400 is introduced into the receiving slot IH in the direction indicated by arrow A1, the first terminal portion 330A may be pressed in the direction indicated by arrow A2. In this case, the first terminal portion 330A may have elastic force suitable for maintaining connection with the cell connector 400 while preventing the cell connector 400 inserted into and received in the receiving slot IH from being separated from the receiving slot IH.

As shown in FIG. 8A, the first separator 300a-k is manufactured such that a protruding piece 332 for forming the first terminal portion 330A protrudes from the edge 300e of the first separator 300a-k.

Thereafter, as shown in FIG. 8B, the protruding piece 332 is bent from the edge 300e of the first separator 300a-k to the interior of the recess HP, thereby forming the first terminal portion 330A in the form of an elastic piece having a curved shape as shown in FIG. 7. A second terminal portion 410 of the cell connector 400 to be described below may come into contact with the elastic piece. The elastic piece to be mentioned below may refer to the first terminal portion 330A.

Referring to FIGS. 5A and 8A, the first terminal portion 330A includes first and second ends 330e1 and 330e2 and an intermediate portion 330c.

In the first terminal portion 330A, the first end 330e1 corresponds to a portion connected to the edge 300e of the first separator 300a-k. The second end 330e2 corresponds to a portion located opposite the first end 330e1 in the second direction. The intermediate portion 330c corresponds to a portion that is disposed between the first end 330e1 and the second end 330e2 and has a curved shape.

The recess HP formed by the first gasket 310 may be formed by a bottom surface 310B and a side surface 310S.

The bottom surface 310B may have one side connected to the first end 330e1 and contacting the edge 300e and may be spaced apart from the second end 330e2 in the first direction.

The side surface 310S is a portion that faces an end 410e of the second terminal portion 410, inserted into and received in the receiving slot IH, in the second direction. The side surface 310S is bent and extends in the first direction from the opposite side of the bottom surface 310B.

According to an embodiment, in order to stop movement of the second end 330e2 in the second direction when the elastic piece 330A is pressed in the direction indicted by arrow A2 shown in FIG. 7, the length between one side and the opposite side of the bottom surface 310B in the second direction may be determined so that the elastic piece, which is the first terminal portion 330A engaged with the second terminal portion 410, is maintained in a curved shape.

In other words, when the second terminal portion 410 is inserted into the receiving slot IH and comes into contact with the first terminal portion 330A, the elastic piece is pressed in the −x-axis direction indicated by arrow A2, and accordingly, the second end 330e2 of the first terminal portion 330A moves toward the side surface 310S. In this case, the side surface 310S needs to stop the second end 330e2 so that the first terminal portion 330A is maintained in a curved shape. For this reason, the length of the bottom surface 310B needs to be appropriately determined.

According to an embodiment, in order to allow the elastic piece 330A to be maintained in a curved shape after being pressed by the second terminal portion 410, as shown in FIG. 8A, a first length L1 of the protruding piece 332 in the second direction before being bent may be longer than a second length L2 from the edge 330e of the bottom surface 310B to the side surface 310S.

If the first length L1 is shorter than the second length L2, when the first terminal portion 330A, which is the elastic piece, is pressed by the second terminal portion 410, the shape of the first terminal portion 330A may be changed from the curved shape to a flat shape. Although the first length L1 is longer than the second length L2, because the elastic piece 330A has a curved shape, the second end 330e2 may be spaced apart from the side surface 310S before insertion of the second terminal portion 410 into the receiving slot IH. In other words, as shown in FIG. 8B, a third length L3 of the protruding piece 332 in the second direction after being bent to have a curved shape may be shorter than the second length L2.

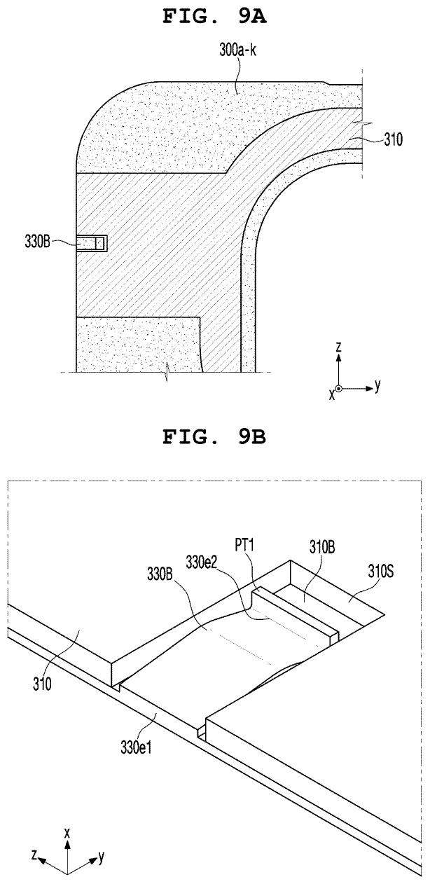

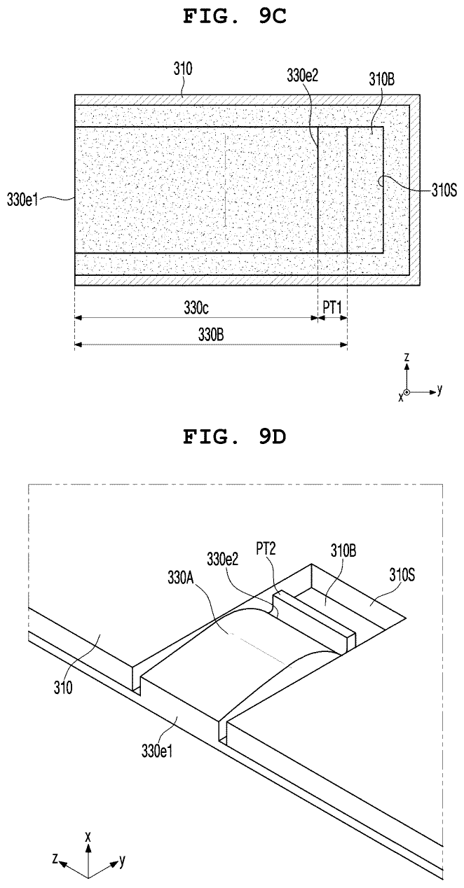

FIGS. 9A to 9C are, respectively, a partial side view, a partial perspective view, and a partial plan view of a first separator 300a-k, a first gasket 310, and a first terminal portion 330B according to another embodiment. FIG. 9D is a partial perspective view of a first separator 300a-k, a first gasket 310, and a first terminal portion 330B according to still another embodiment.

As shown in FIGS. 9A-9C, because a first terminal portion 330B is identical to the first terminal portion 330A except for further including a first protruding portion PT1, the same portions are denoted by the same reference numerals, and duplicate description thereof has been omitted.

The first terminal portion 330B shown in FIGS. 9A-9C may further include a first protruding portion PT1, which is bent and protrudes from the second end 330e2, which is opposite the first end 330e1, in the first direction away from the bottom surface 310B. In this case, instead of the above-described second end 330e2, the first protruding portion PT1 may be stopped by the side surface 310S.

Alternatively, referring to portion A in FIG. 7 and FIG. 9D, the first separator 300a-k may further include a second protruding portion PT2. The second protruding portion PT2 may be bent and protrude from the bottom surface 310B in the first direction, and may be spaced apart from the second end 330e2 and the side surface 310S in the second direction. Because the configuration shown in FIG. 9D is identical to the configuration shown in FIGS. 8A and 8B except that the second protruding portion PT2 is further disposed, duplicate description of the same configuration has been omitted.

In this case, the second end 330e2 may be stopped by the second protruding portion PT2 instead of the above-described side surface 310S.

The following description of the first terminal portion 330A may also be applied to the first terminal portion 330B.

According to an embodiment, a first width Z1 of the receiving slot IH in the third direction intersecting each of the first and second directions may be larger than a second width Z2 of the second terminal portion 410 in the third direction. In addition, a third width Z3 of the first terminal portion 330A in the third direction may be smaller than the second width Z2.

In addition, a first thickness T1 of the second terminal portion 410 in the first direction may be larger than a second thickness T2 of the first separator 300a-k. The first thickness T1 may be determined to satisfy Expression 1 below.

T1<T3−T2 [Expression 1]

In Expression 1, T3 represents a third thickness of the first gasket 310.

The cell connector 400 may include a second terminal portion 410. The second terminal portion 410 may be removably inserted into the receiving slot IH and may be engaged with the first terminal portion 330A in a contact manner in the first direction. According to an embodiment, the first terminal portion 330A and the second terminal portion 410 may be engaged with each other in a surface contact manner. In other words, a first surface S1 of the second terminal portion 410 and a second surface S2 of the elastic piece, which is the first terminal portion 330A, may be brought into surface contact with and connected to each other. As described above, the curved portion of the elastic piece 330A may be pressed due to the surface contact. Contact between the first surface S1 and the second surface S2 may be maintained due to elastic force generated when the first terminal portion 330A is pressed.

In addition, the aforementioned third length L3 of the elastic piece 330A that has been bent may be shorter than a fourth length L4 of the second terminal portion 410 in the second direction. For example, in order to prevent the second terminal portion 410 from being introduced too deeply into the receiving slot IH, the second terminal portion 410 may further include a stopper STP protruding from a body BD thereof in a direction intersecting the second direction (e.g., in the third direction). The controller 500 may be connected to the other end 412e (or fourth end) of the second terminal portion 410, which is opposite one end 410e (or third end) of the second terminal portion 410, to measure the voltage of each of the unit cells. To this end, the body BD of the second terminal portion 410 may be formed of an electrically conductive material.

In this it is possible to determine the performance of the cell stack 122 and whether the cell stack 122 operates normally or abnormally using the measured cell voltage. For example, the controller 500 may refer to a circuit including a measurement device and an electronic control unit for operating the fuel cell in a vehicle.

Hereinafter, a method of manufacturing the fuel cell apparatus according to an embodiment is described with reference to the accompanying drawings.

As shown in FIG. 8A, a thin and long strip-shaped protruding piece 332 is formed so as to protrude in the second direction from the edge 300e of the first separator 300a-k.

Thereafter, as shown in FIG. 8B, the strip-shaped protruding piece 332 is folded once to the interior of the recess HP to form the first terminal portion 330A.

Then, the second gasket 320 (refer to FIG. 3A) or the insulating layer 340 (refer to FIG. 3B) is placed on the first separator 300a-k in which the recess HP is formed, thereby completing the fuel cell 100 having the receiving slot IH.

Hereinafter, a fuel cell apparatus according to a comparative example and the fuel cell apparatus according to an embodiment of the present disclosure are described.

A fuel cell and a cell connector according to a comparative example are disclosed in related art document Korean Patent Registration No. 10-2659055-00-00 (hereinafter referred to as the “fuel cell apparatus according to the comparative example”).

Generally, assembly of a cell connector to a separator of a fuel cell is manually performed, resulting in a high labor cost. The fuel cell apparatus according to the comparative example is configured such that a cell connector is engaged with a thin plate of a separator, which may cause an increase in cycle time.

The cell connector of the fuel cell apparatus according to the comparative example includes a housing that is at least partially received in a receiving slot of the separator. In contrast, in the fuel cell apparatus 10 according to an embodiment, the first gasket 310 and the second gasket 320 serve as the housing of the cell connector of the comparative example, as shown in FIGS. 3A and 4A, or the first gasket 310 and the insulating layer 340 serve as the housing of the cell connector of the comparative example, as shown in FIGS. 3B and 4B. Thus, the cell connector 400 of an embodiment has no separate housing.

In addition, in the fuel cell apparatus according to the comparative example, after the housing is coupled to the separator, a connection terminal is mounted to the housing, and the separator is connected to a controller using a wire. In contrast, the fuel cell apparatus according to an embodiment does not require such a wire, and has simple configuration in which the second terminal portion 410 connects the first terminal portion 330A or 330B of the separator to the controller 500.

In the fuel cell apparatus 10 according to an embodiment, in order to prevent the elastic piece of the first terminal portion 330A or 330B from being bent and mechanically deformed when inserting the second terminal portion 410 into the receiving slot IH, the side surface 310S may serve as a stopper for preventing deformation of the first terminal portion 330A.

In addition, according to an embodiment, as described above, the second width Z2 of the second terminal portion 410 in the third direction is formed to be larger than the third width Z3 of the first terminal portion 330A in the third direction. Accordingly, it is possible to ensure stable electrical contact between the first terminal portion 330A and the second terminal portion 410.

In addition, the first width Z1 of the receiving slot IH is larger than the third width Z3 of the first terminal portion 330A in the third direction and is larger than the second width Z2 of the second terminal portion 410 in the third direction. Accordingly, assemblability and structural stability may be improved.

In addition, in the fuel cell apparatus according to the comparative example, voltage generated in the fuel cell is transmitted to the controller through the separator tab, the connection terminal, and the wire. In contrast, in the fuel cell apparatus according to an embodiment, voltage generated in the fuel cell 100 is transmitted to the second terminal portion 410, and the second terminal portion 410 provides the voltage to the controller 500. Thus, wires or the like are not required, and the configuration is simplified.

In addition, in the fuel cell apparatus according to the comparative example, a tab must be formed on the separator in order to assemble the housing to the separator. In contrast, in an embodiment, connection of the second terminal portion 410 to the first terminal portion 330A does not require a tab, and thus the separator has simple configuration.

In addition, as shown in Expression 1 above, the first thickness T1 is formed to be less than the value obtained by subtracting the second thickness T2 from the third thickness T3. Accordingly, assembly between the second terminal portion 410 and the first terminal portion 330A may be easily performed.

In addition, in order to secure the rigidity of the second terminal portion 410, the first thickness T1 of the second terminal portion 410 needs to be large. For example, as described above, the first thickness T1 may be larger than the second thickness T2.

As a result, since the housing of the cell connector 400 is implemented using the gaskets 310 and 320 (or 310 and 340) mounted on the separators 300a-k and 300b-k, the configuration of the cell connector 400 according to an embodiment is simple, and assembly between the fuel cell 100 and the cell connector 400 is also simple and efficient, compared to the cell connector according to the comparative example.

The fuel cell apparatus 10 according to an embodiment described above may be applied to vehicles, aircraft, ships, stationary power generation systems, and the like. However, the disclosure is not limited thereto.

As should be apparent from the above description, according to a fuel cell apparatus according to an embodiment, the configuration of a cell connector is simple, and assembly between a fuel cell and the cell connector is also simple and efficient.

However, the effects achievable through the disclosure are not limited to the above-mentioned effects, and other effects not mentioned herein should be clearly understood by those having ordinary skill in the art from the above description.

The above-described various embodiments may be combined with each other without departing from the scope of the present disclosure unless they are incompatible with each other.

In addition, for any element or process that is not described in detail in any of various embodiments, reference may be made to the description of an element or a process having the same reference numeral in another embodiment, unless otherwise specified.

While the present disclosure has been particularly shown and described with reference to example embodiments thereof, these embodiments are only proposed for illustrative purposes, and do not restrict the present disclosure. It should be apparent to those having ordinary skill in the art that various changes in form and detail may be made without departing from the essential characteristics of embodiments set forth herein. For example, respective configurations set forth in embodiments may be modified and applied. Further, differences in such modifications and applications should be construed as falling within the scope of the present disclosure as defined by the appended claims.

What is claimed is:

1. A fuel cell apparatus comprising:
a fuel cell including a plurality of unit cells stacked in a first direction and separators disposed so as to be spaced apart from each other in the first direction; and
a cell connector mounted to the fuel cell in a second direction intersecting the first direction,
wherein the separators include a plurality of separator pairs, each separator pair including first and second separators adjacent to each other,
wherein the fuel cell further includes
a first gasket disposed so as to form a recess contacting an edge of the first separator, the first gasket being insulative,
a second gasket disposed on the second separator and facing the recess in the first direction to define a receiving slot together with the recess, the second gasket being insulative, and
a first terminal portion removably disposed in the receiving slot, the first terminal portion being elastic in the first direction, and
wherein the cell connector includes a second terminal portion inserted into the receiving slot in the second direction to be engaged with the first terminal portion in a contact manner in the first direction.

2. The fuel cell apparatus according to claim 1, wherein the first terminal portion includes an elastic piece bent from the edge to an interior of the recess so as to have a curved shape, and wherein the second terminal portion contacts the elastic piece.

3. The fuel cell apparatus according to claim 2, wherein the elastic piece includes:
a first end connected to the edge;
a second end located opposite the first end in the second direction; and
an intermediate portion disposed between the first end and the second end, the intermediate portion having the curved shape.

4. The fuel cell apparatus according to claim 3, wherein the elastic piece further includes a first protruding portion bent and protruding from the second end in the first direction away from a bottom surface.

5. The fuel cell apparatus according to claim 3, wherein the recess includes:
a bottom surface connected to the first end and spaced apart from the second end in the first direction; and
a side surface facing a third end of the second terminal portion, inserted into and received in the receiving slot, in the second direction, wherein the side surface extends from the bottom surface in the first direction.

6. The fuel cell apparatus according to claim 5, wherein a length of the bottom surface in the second direction is determined so that the elastic piece of the first terminal portion engaged with the second terminal portion is maintained in the curved shape by stopping movement of the second end in the second direction.

7. The fuel cell apparatus according to claim 5, further comprising a controller connected to a fourth end of the second terminal portion, the fourth end being opposite the third end, wherein the controller is configured to measure voltage of each of the plurality of unit cells.

8. The fuel cell apparatus according to claim 5, wherein the first separator includes a second protruding portion bent and protruding from the bottom surface in the first direction and spaced apart from the second end and the side surface.

9. The fuel cell apparatus according to claim 5, wherein the elastic piece has a first length in the second direction before being bent to have the curved shape, and wherein the first length is longer than a second length from the edge of the bottom surface to the side surface.

10. The fuel cell apparatus according to claim 9, wherein the elastic piece has a third length in the second direction after being bent to have the curved shape, and wherein the third length is shorter than the second length.

11. The fuel cell apparatus according to claim 10, wherein the third length is shorter than a fourth length of the second terminal portion in the second direction.

12. The fuel cell apparatus according to claim 1, further comprising an insulating layer disposed between the first gasket and the second gasket to define the receiving slot together with the recess, wherein the first and second separators are included in each of the plurality of unit cells.

13. The fuel cell apparatus according to claim 1, wherein the plurality of unit cells includes first and second unit cells adjacent to each other, and wherein the first separator is included in one of the first and second unit cells, and the second separator is included in a remaining one of the first and second unit cells.

14. The fuel cell apparatus according to claim 1, wherein a first width of the receiving slot in a third direction intersecting each of the first and second directions is greater than a second width of the second terminal portion in the third direction.

15. The fuel cell apparatus according to claim 14, wherein a third width of the first terminal portion in the third direction is less than the second width.

16. The fuel cell apparatus according to claim 1, wherein a first thickness of the second terminal portion in the first direction is greater than a second thickness of the first separator in the first direction.

17. The fuel cell apparatus according to claim 16, wherein the first thickness is determined as:
T1<T3−T2,
where T1 represents the first thickness, T2 represents the second thickness, and T3 represents a third thickness of the first gasket in the first direction.

18. The fuel cell apparatus according to claim 1, wherein the first terminal portion and the second terminal portion are engaged with each other in a surface contact manner.
